(19) United States
(12) Patent Application Publication
(10) Pub. No.: US 2008/0160930 A1
(43) Pub. Date: Jul. 3, 2008

(54) Positioning

(76) Inventors: Kimmo Kalliola, Helsinki (FI); Hannu Kauppinen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/619,557

(22) Filed: Jan. 3, 2007

(51) Int. Cl. H04B 1/38

(52) U.S. Cl. 455/90.1

(57) ABSTRACT

A system, including: an electrical network fitted to a building, for distributing electrical power within the building to make the building operational, the network comprising a plurality of nodes for outputting the electrical power each node comprising a receptacle for receiving a lighting element; and a plurality of radio devices, retrofitted to the operational building, wherein each of the radio devices is operable, when powered via a respective node of the network, to transmit data relating to positioning.

### FIELD OF THE INVENTION

Embodiments of the present invention relate to apparatus for use in positioning. In particular, they relate to positioning apparatus that is powered by an existing electrical distribution system of a building, a system comprising a plurality of apparatus and a method for providing the system.

### BACKGROUND TO THE INVENTION

It is often desirable to know the location of a person or device on a map or building plan. However, positioning systems for determining such a location may be expensive to set up and/or require the installation of a dedicated infrastructure.

For example, the installation of a positioning system in a building may require a dedicated network to be set up within the building, to supply electrical power to the radio transceivers of the system. It may also require a dedicated network to be set up for data exchange between the radio transceivers and/or a central computer.

The high cost and time requirements of installing such a positioning system act as a deterrent to providing the system.

### BRIEF DESCRIPTION OF THE INVENTION

According to one embodiment of the invention, there is provided a system, comprising: an electrical network fitted to a building, for distributing electrical power within the building to make the building operational, the network comprising a plurality of nodes for outputting the electrical power, each node comprising a receptacle for receiving a lighting element; and a plurality of radio devices, retrofitted to the operational building, wherein each of the radio devices is operable, when powered via a respective node of the network, to transmit data relating to positioning.

According to another embodiment of the invention, there is provided a method, comprising: retrofitting a plurality of radio devices to an operational building, the building having been made operational by fitting to the building an electrical network for distributing power within the building, the retrofitting including arranging the plurality of radio devices to be powered via nodes of the electrical network, wherein each node comprises a receptacle for receiving a lighting element.

A system is provided which uses an existing electrical power distribution network of a building to power a plurality of radio devices. Therefore, advantageously, the system is much cheaper to install than a system requiring its own dedicated power distribution network.

According to a further embodiment of the invention, there is provided an apparatus, comprising: an input power connector, having a first physical configuration, for coupling with an output power connector of a power supply having a second physical configuration, to receive electrical power; an output power connector, having the second physical configuration, for coupling with an input power connector of a further apparatus, to provide received electrical power to the further apparatus; and a radio transmitter operable, when the input power connector is coupled with the output power connector of the power supply, to transmit radio signals.

According to another embodiment of the invention, there is provided an apparatus, comprising: power input means, having a first physical configuration, for coupling with power output means of a power supply having a second physical configuration, to receive electrical power; power output means, having the second physical configuration, for coupling with power input means of a further apparatus, to provide received electrical power to the further apparatus; and means for transmitting radio signals when the power input means is coupled with the power output means of the power supply, to transmit radio signals.

Advantageously, the apparatus is able to receive electrical power to provide received electrical power to the further apparatus via an output power connector of the apparatus.

According to a further embodiment of the invention, there is provided a system, comprising: a lighting network fitted to a building, the lighting network having a plurality of lighting nodes, each lighting node comprising a connector for electrically connecting to a lighting element; and a plurality of radio devices, operable when powered via a respective lighting node of the lighting network, to transmit data relating to positioning.

According to another embodiment of the invention, there is provided a method, comprising: arranging a plurality of radio devices in a building to be to be powered via lighting nodes of a lighting network of the building, wherein each lighting node comprises a connector for electrically connecting to a lighting element.

### BRIEF DESCRIPTION OF THE DRAWINGS

For a better understanding of the present invention reference will now be made by way of example only to the accompanying drawings in which:

FIG. 1 illustrates a positioning system;

FIG. 2 illustrates an apparatus for use in the positioning system;

FIG. 3 illustrates a radio device for use in the positioning system;

FIG. 4 illustrates another apparatus for use in the positioning system; and

FIG. 5 illustrates a further apparatus for use in the positioning system.

### DETAILED DESCRIPTION OF EMBODIMENTS OF THE INVENTION

The Figures illustrate a system 100, comprising: an electrical network 150 fitted to a building 200, for distributing electrical power within the building 200 to make the building 200 operational, the network 150 comprising a plurality of nodes 101-106 for outputting the electrical power, each node 101-106 comprising a receptacle for receiving a lighting element; and a plurality of radio devices 20, retrofitted to the operational building 200, wherein each of the radio devices 20 is operable, when powered via a respective node 101-106 of the network 150, to transmit data 161 relating to positioning.

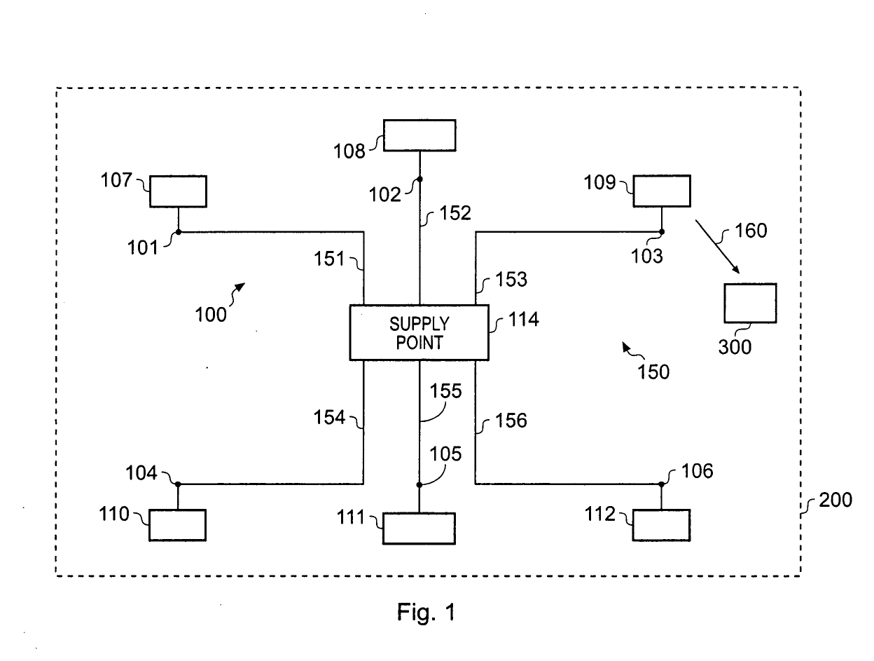

FIG. 1 illustrates a building 200 with an integrated network 150 for distributing electrical power around the building 200. The power distribution network 150 may be embedded within the fabric of the building. Mains/line/grid electrical power is supplied to the building at the supply point 114. The electrical power that is supplied to the supply point may, for example, be in the form of alternating current supplied at around at 110V (US and Japan) or 220-240V (Europe).

The supplied electrical power is distributed around the building 200 by the power distribution network 150. The power distribution network 150 includes a plurality of nodes 101-106 for outputting the distributed electrical power. Each of the output nodes 101-106 of the distribution network 150 may be in different rooms of the building. A single room may also have more than one output node 101-106.

When electrical power is distributed around the building 200 and available for output at nodes 101-106, the building is considered to be operational. When the building is operational it may, for example, be used as an office, a home or a shopping center.

It will be appreciated by the skilled reader that, for the purposes of explaining embodiments of the invention, the power distribution network 150 has been simplified. For example, in the power distribution network 150 illustrated in FIG. 1, each of the branches 151-156 of the power distribution network 150 emanate directly from the electrical supply point 114. In practice, some of the branches of the distribution network 150 may emanate from other branches.

FIG. 1 also illustrates a plurality of positioning apparatus 107-112 which are part of a positioning system 100. The positioning apparatus 107-112 are retrofitted to the operational building and are powered via the output nodes 101-106 of the power distribution network 150. That is, the retrofitted positioning apparatus 107-112 are fitted to the building 200 after it is deemed to be operational and are not embedded into the fabric of the building 200. The positioning apparatus 107-112 may be considered to be “added on” to the operational building 200.

It may be that the apparatus 107-112 are directly connected to the nodes 101-106 to receive electrical power. For example, some or all of the nodes 101-106 may comprise plug sockets, for receiving a standard two or three pin plug. Alternatively or additionally, some or all of the nodes may comprise light sockets for receiving lighting elements, such as light bulbs, fluorescent lighting tubes or LED lights. Alternatively or additionally, some or all of the nodes 101-106 may be for supplying power to smoke detectors.

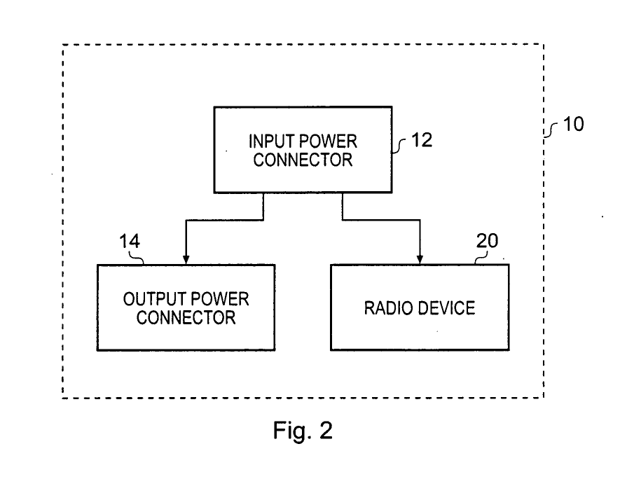

FIG. 2 illustrates one embodiment of an apparatus 107-112. This embodiment of an apparatus is represented by the reference numeral 10. The apparatus 10 comprises an input power connector 12, which is electrically connected to an output power connector 14 and a radio device 20. The apparatus 10 is small enough to be carried in the palm of a person's hand.

The input power connector 12 couples directly to an output power connector 14 at one of the nodes 101-106, to receive electrical power from the node 101-106. The coupling may be in the form of a male/female mating connection. For example, the output power connector of a node may comprise one or more receptacles for receiving one or more protruding members of the input connector 12 of the apparatus 10. Where a node is a plug socket for receiving a two pin-plug, the input power connector 12 is in the form of a two pin plug. Where the node is a light socket for receiving a lighting element, the input power connector 12 has the same form as the input power connector of a lighting element that connects to the output power connector of the node 101-106.

The output power connector 14 of the apparatus reproduces the output power connector of the node 101-106 to which the input power connector 12 is coupled. When an input power connector of a further apparatus/device is connected to the output power connector 14 of the apparatus, electrical power is distributed to the further apparatus to enable the further apparatus to function. If the output power connector of a node 101-106 is a light socket, the further apparatus may be a lighting element. Where the output power connector of a node 101-106 is a plug socket, the further apparatus could be anything that is operable to receive electrical power from a plug socket.

The input power connector 12 is also operable to supply received electrical power to the radio device 20, to enable the radio device 20 to function. The apparatus 10 may comprise a voltage reducer to reduce the voltage at the input connector 12 to a low voltage for providing to the radio device 20. A low voltage may be considered to be, for example, 3 volts or below. The apparatus 10 may also comprise a rectifier to convert the received alternating current to direct current, to provide to the radio device 20.

Advantageously, the apparatus 10 is able to receive power via the input power connector 12 to power the radio device 20, and is also able to distribute power to a further apparatus by reproducing an output power connector of a node 101-106 of the network 150. Therefore, the apparatus 10 may be considered to be parasitic in nature.

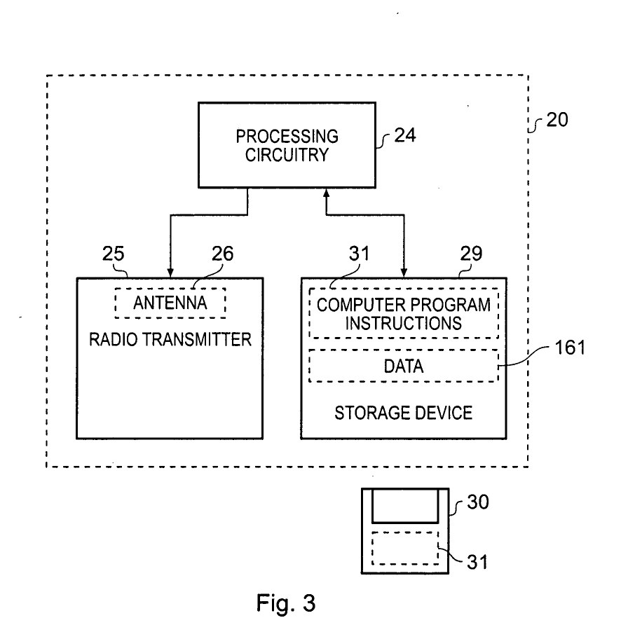

FIG. 3 illustrates the radio device 20 of the apparatus 10 in more detail. The radio device 20 comprises processing circuitry 24, a storage device 29 and a radio transmitter 25.

The processing circuitry 24 may be any type of processing circuitry. For example, it may be a programmable processor that interprets computer program instructions 31 and processes data. Alternatively, the processing circuitry 24 may be, for example, programmable hardware with embedded firmware. The processing circuitry 24 may be a single integrated circuit or a set of integrated circuits (i.e. a chipset). The processing circuitry 24 may also be a hardwired, application-specific integrated circuit (ASIC).

The processing circuitry 24 is connected to write to and read from the storage device 29. The storage device 29 is, in this example, operable to store computer program instructions 31 and data 161 relating to positioning. The data 161 relating to positioning may include an indication of the type of the radio device 20 and may include an identification code or address of the radio device 20. Either or both the computer program instructions 31 and the data 161 may be permanently stored in the storage device 29.

The storage device 29 may be a single memory unit or a plurality of memory units. If the storage device 29 comprises a plurality of memory units, part or the whole of the computer program instructions 31 may be stored in the same or different memory units. Also, some of the memory units may be read-only memory units.

The computer program instructions may arrive at the radio device 20 via an electromagnetic carrier signal or be copied from a physical entity 30 such as a computer program product, a memory device or a record medium such as a CD-ROM or DVD.

The processing circuitry 24 is operable to provide an output to the radio transmitter 25. The radio transmitter 25 comprises an antenna 26, and is operable to transmit radio frequency signals. The radio transmitter 25 may be part of a radio transceiver which comprises a radio receiver.

The radio frequency signals that the radio transmitter 25 is operable to transmit may be “low power” signals, such as those formulated according to the forthcoming Wibree specification. Further information regarding Wibree technology (formerly known as the Bluetooth Low End Extension) is described in Mauri Honkanen et al., “Low End Extension for Bluetooth” IEEE Radio and Wireless Conference RAWCON 2004, Atlanta, Ga., September, 2004, pages 19-22.’ The radio frequency signals may also be formulated according to specifications relating to UWB or Zigbee technologies.

For example, low power radio frequency signals may have a transmission range of 100 meters or less. Some low power radio frequency signals may have a transmission range of 10 meters or less.

The radio transmitter 25 may be operable to function as a radio beacon. For example, the radio transmitter 25 may transmit radio signals periodically (e.g. six times per second). The transmitted radio signal may include the data 161 relating to positioning stored in the storage device 29.

When the apparatus 10 comprises a radio receiver, the radio receiver may be operable to receive radio signals for wirelessly configuring the radio device 20. For example, the received radio signals may specify how often the radio transmitter is to transmit periodic radio signals.

In FIG. 1, an apparatus 109 is illustrated transmitting a radio signal 160 to a portable electronic device 300. The portable electronic device 300 may, for example, be operable as a mobile telephone. The radio signal 160 may include information identifying the radio device 20 of the apparatus 109, such as an identification code.

The portable electronic device 300 may be operable to receive a database relating to the plan of the building 200 from a remote server of a service provider. The database may be stored in a storage device of the portable electronic apparatus 300. The database may indicate where the apparatus 107-112 are located in the building by associating the identification code of an apparatus 107-112 with a particular position in the building 200.

If the transmission range of the apparatus 107-112 is known, reception of an identification code of an apparatus 107-112 enables the portable electronic device 300 to determine that its location is within the transmission range of the apparatus 107-112. If more than one identification code is received from the apparatus 107-112, the portable electronic device 300 determines that it is located in a region where the transmission ranges of the apparatus 107-112 corresponding to the received identification codes overlap. The received signal strength of the signal 160 may also be used by the portable electronic device 300 to determine its location.

In one embodiment, the database may associate each one of the apparatus 107-112 with a respective room in the building 200. If the portable electronic device 300 receives an identification code from an apparatus 107-112, the portable electronic device 300 is able to identify which room it is located in using the database.

In another embodiment, the database is stored at a remote server of a service provider and the portable electronic device 300 may transmit data relating to its position to the remote server, such as the identification code and the received signal strength of a signal received from an apparatus 107-112. The remote server may then determine the position of the portable electronic device 300 using the database and the information received from the portable electronic device 300.

The remote server may store the determined position, enabling the user of the portable electronic device 300 and/or third parties (e.g. the emergency services) to locate the portable electronic device 300 by accessing the stored position at the remote server. Additionally or alternatively, details of the determined position may be transmitted by the service provider to the portable electronic device 300 and/or a device of a third party.

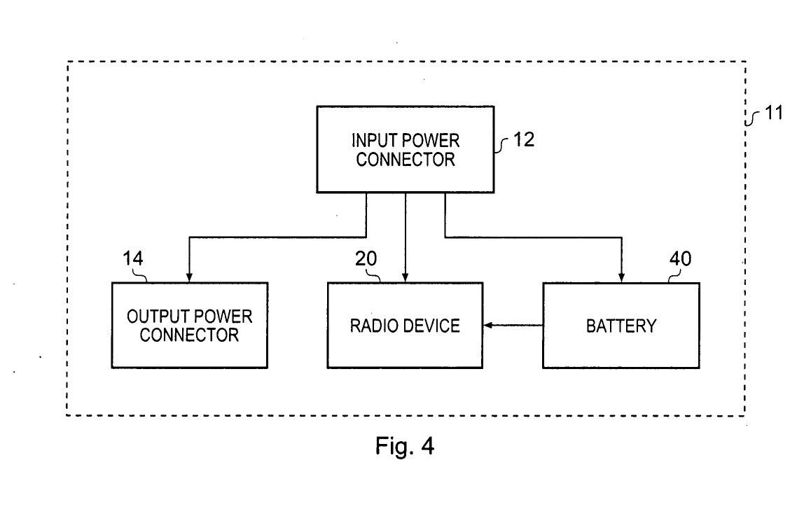

FIG. 4 illustrates another embodiment of an apparatus 11. Any of the apparatus 107-112 illustrated in FIG. 1 may take the form of the apparatus 11 illustrated in FIG. 4. The apparatus 11 includes the same input power connector 12, output power connector 14 and radio device 20 as the apparatus 10 in FIG. 2. The apparatus 11 of FIG. 4, however, differs from the apparatus 10 of FIG. 2 in that it comprises a battery 40. The input power connector 12 distributes electrical power to the battery 40 to charge it. The battery 40 may, for instance, be trickle charged.

When the input power connector 12 is connected to a node 101-106 of the distribution network 150 to receive power from the network 150, it distributes power to the radio device 20 to enable the radio device 20 to function. However, when the input connector 12 does not receive power from the network 150, power is supplied to the radio device 20 by the battery 40.

If the input power connector 12 is connected to a light socket, it may not receive power from the network 150 when a switch associated with the light socket is switched to “off”. In this situation, power may be provided to the radio device 20 by the battery 40.

In some embodiments of the invention, the battery 40 may provide power to the radio device 20 if the power distribution network 150 does not distribute power to the nodes 101-106 for any reason (for example, if electrical power ceases to be provided to the supply point 114).

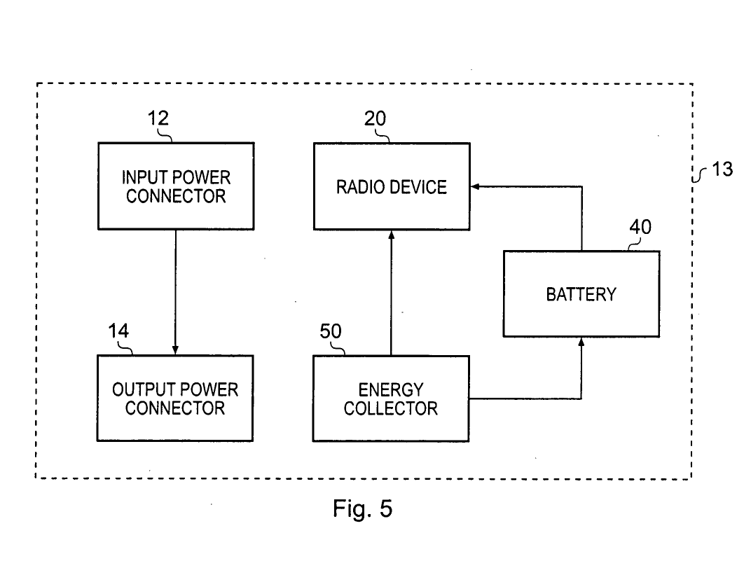

FIG. 5 illustrates another embodiment of an apparatus 13. Any of the apparatus 107-112 illustrated in FIG. 1 may take the form of the apparatus 11 illustrated in FIG. 4. The apparatus 13 includes the same radio device 20 as the apparatus 10 and 11 in FIG. 2 and FIG. 4. The apparatus 13 of FIG. 5, however, differs from the apparatus 10 of FIG. 2. in that it comprises an energy collector 50. Also, in apparatus 13 shown in FIG. 5, the input power connector 12 and output power connector 14 are optional components.

The energy collector 50 is for collecting energy to charge the battery 40 and/or to power the radio device 20 directly. The energy collector 50 may comprise a photovoltaic device for receiving optical radiation and converting it into electrical current, which is ultimately used to power the radio device 20. The energy collector 50 may comprise a thermionic device for receiving heat and converting it into electrical current, which is ultimately used to power the device 20.

If the apparatus 13 is located close to a lighting element, for example, where the input power connector 12 is coupled to a light socket, heat or light that is output by the lighting element may be collected by the energy collector 50 and used to power the radio device 20. The radio device 20 is indirectly powered by a node 101-106 of the power distribution network 150 because the electrical energy that is output by a node 101-106 is converted into a different form of energy (e.g. heat or light) before being converted back into electrical energy (by the energy collector) to power the radio device 20.

Although embodiments of the present invention have been described in the preceding paragraphs with reference to various examples, it should be appreciated that modifications to the examples given can be made without departing from the scope of the invention as claimed. For example, the building 200 may comprise a network for data exchange. The branches of the data exchange network may be situated close to the branches of the power distribution network 150 and nodes of the data exchange network may be adjacent to the nodes of the power distribution network 150.

In this situation, the apparatus 10, 11, 13 and 107-112 may include a data connector for physical coupling with a data connector at a node of the data exchange network. The data connector may be for receiving data via the data exchange network for configuring the radio device 20. The data connector may be used to receive information that determines how often the radio transmitter transmits radio signals, for example.

In one implementation, the power distribution network 150 may be used to transfer data. In another implementation, the power distribution network 150 may not be used to transfer data.

A battery backup may be provided in the system 100 to provide power to the nodes in the event that electrical power ceases to be provided to the supply point 114. The battery backup may comprise a power source at the supply point 114 which distributes power to each of the nodes 101-106. Alternatively or additionally, a separate battery backup may be provided at each of the nodes 101-106.

While endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A system, comprising:
an electrical network fitted to a building, for distributing electrical power within the building to make the building operational, the network comprising a plurality of nodes for outputting electrical power, each node comprising a receptacle for receiving a lighting element; and
a plurality of radio devices, retrofitted to the operational building, wherein each of the radio devices is operable, when powered via a respective node of the network, to transmit data relating to positioning.

2. A system as claimed in claim 1, wherein the radio devices are directly powered via the nodes.

3. A system as claimed in claim 1, the system further comprising a multiplicity of batteries for supplying power to a multiplicity of radio devices, wherein the batteries are trickle charged via a multiplicity of nodes.

4. A system as claimed in claim in claim 3, wherein the multiplicity of radio devices is powered by the multiplicity of batteries when the multiplicity of radio devices is not powered by the multiplicity of nodes of the network.

5. A system as claimed in claim 1, wherein the radio devices are indirectly powered via the nodes.

6. A system as claimed in claim 1, the system further comprising a multiplicity of energy collectors, for collecting energy from the plurality of nodes of the electrical network, in order to enable the network to power the radio devices.

7. A system as claimed in claim 6, wherein each energy collector comprises a photovoltaic device for receiving optical radiation and for converting the received radiation into electrical power to provide to a radio device.

8. A system as claimed in claim 6, wherein each energy collector comprises a thermionic device for receiving heat and for converting the heat into electrical power to provide to a radio device.

9. A system as claimed in claim 1, where the data relating to positioning is an identification code of the radio device.

10. A system as claimed in claim 1, wherein the radio devices are operable to transmit data relating to positioning periodically.

11. A system as claimed in claim 1, further comprising a portable electronic device for receiving the transmitted data relating to positioning.

12. A radio device for use in the system as claimed in claim 1.

13. A method, comprising:
retrofitting a plurality of radio devices to an operational building, the building having been made operational by fitting to the building an electrical network for distributing power within the building, the retrofitting including arranging the plurality of radio devices to be powered via nodes of the electrical network, wherein each node comprises a receptacle for receiving a lighting element.

14. An apparatus, comprising:
an input power connector, having a first physical configuration, for coupling with an output power connector of a power supply having a second physical configuration, to receive electrical power;
an output power connector, having the second physical configuration, for coupling with an input power connector of a further apparatus, to provide received electrical power to the further apparatus; and
a radio transmitter operable, when the input power connector is coupled with the output power connector of the power supply, to transmit radio signals.

15. An apparatus as claimed in claim 14, wherein the input power connector of the apparatus is for mating with the output power connector of the power supply.

16. An apparatus as claimed in claim 14, wherein the input power connector of the apparatus is for reception by a receptacle of the output power connector of the power supply.

17. An apparatus as claimed in claim 14, wherein the output power connector of the apparatus is for mating with the input power connector of the further apparatus.

18. An apparatus as claimed in claim 14, wherein the output power connector of the apparatus comprises a receptacle for receiving the input power connector of the further apparatus.

19. An apparatus as claimed in claim 14, wherein the radio transmitter is powered by electrical power received from the power supply.

20. An apparatus as claimed in claim 14, wherein the output connector of the power supply and the output connector of the apparatus are receptacles for receiving a lighting element, and the further apparatus is a lighting element.

21. An apparatus, comprising:
power input means, having a first physical configuration, for coupling with power output means of a power supply having a second physical configuration, to receive electrical power;
power output means, having the second physical configuration, for coupling with power input means of a further apparatus, to provide received electrical power to the further apparatus; and
means for transmitting radio signals when the power input means is coupled with the power output means of the power supply, to transmit radio signals.

22. A system, comprising:
a lighting network fitted to a building, the lighting network having a plurality of lighting nodes, each lighting node comprising a connector for electrically connecting to a lighting element; and
a plurality of radio devices, operable when powered via a respective lighting node of the lighting network, to transmit data relating to positioning.

23. A method, comprising:
arranging a plurality of radio devices in a building to be to be powered via lighting nodes of a lighting network of the building, wherein each lighting node comprises a connector for electrically connecting to a lighting element.
